(19) United States
(12) Patent Application Publication
(10) Pub. No.: US 2010/0007143 A1
(43) Pub. Date: Jan. 14, 2010

(54) CONNECTING ASSEMBLY

(75) Inventor: Jorg Altenrath, Lohmar (DE)

Correspondence Address: DYKEMA GOSSETT PLLC, 39577 WOODWARD AVENUE, SUITE 300, BLOOMFIELD HILLS, MI, 48304-5086, US

(73) Assignee: Eaton Fluid Connectors GmbH, Lohmar (DE)

(21) Appl. No.: 12/293,174

(22) PCT Filed: Mar. 8, 2007
(86) PCT No.: PCT/EP07/01988

§ 371 Date: Feb. 22, 2009

(30) Foreign Application Priority Data
Mar. 16, 2006 (DE) 10 2006 012 493.6

(51) Int. Cl. F16L 19/08

(52) U.S. Cl. 285/342

(57) ABSTRACT

A connecting assembly for connecting a pipe with a connecting element having a conical bore is disclosed. The assembly includes: a longitudinal axis; a pipe having a pipe end configured for insertion in the conical bore; a supporting ring having first and second retaining surfaces; a union nut for screwing on threads of the connecting element and forming a tensioning surface; a cutting ring; and a collar disposed between the first pipe end and the first retaining face. The cutting ring is seated in the conical bore of the supporting ring and provided with a pressure surface for the impingement of force by the tensioning surface of the union nut, and has at least one first cutting edge. A collar bulge is provided on the outer surface face of the pipe can be formed when the first cutting edge cuts into the pipe. The outer diameter of the collar bulge is larger than the smallest support ring internal diameter.

The invention relates to a connecting assembly for connecting a pipe or pipe connecting piece with a connecting element which has a conical bore that tapers starting from a face, said connecting assembly comprising a longitudinal axis, a supporting ring which, extending from a first retaining surface, has a conical bore flared in the same direction as the conical bore of the connecting element and which is supported on the face of the connecting element with a second retaining surface, and comprising a union nut that can be screwed onto a thread of the connecting element and thus forms a tensioning surface, and comprising a cutting ring that is seated in the conical bore of the supporting ring and has a pressure surface to be impinged upon by the tensioning surface of the union nut.

Such a connecting assembly has been known from document DE 196 37 129 C2. Referring to this connecting assembly, the tensioning surface of the union nut has a conical form. The supporting ring has a surface facing the tensioning surface of the union nut, said nut displaying an angle of taper matching the tensioning surface. In assembled state, the cutting ring penetrates the conical bore of the supporting ring to an extent that the supporting ring, as well as the cutting ring, abut against the tensioning surface of the union nut.

Document DE 40 38 539 C1 shows a connecting assembly, in which the cutting ring is supported via a surface extending radially with respect to the pipe axis against an abutment surface of a sealing ring, said abutment surface also extending radially with respect to the pipe axis. In this case, the cutting ring and the sealing ring are tensioned axially, one after the other, between the union nut and the connecting element.

Referring to the connecting assemblies of the aforementioned type, a force impinges axially on the cutting ring when the union nut is screwed onto the connecting element, thus creating a collar bulge on the outside surface of the pipe. In assembled state of the connecting assembly the cutting ring is axially supported against this bulge. As a result of this, the pipe is axially supported against the cutting ring, and said cutting ring is supported against the union nut, so that the pipe cannot be pulled out of the connecting element. Consequently, it is important for a reliable connection that the cutting ring cut deeply enough into the pipe in order to securely hold the pipe.

To accomplish this, it is common to first assemble the connecting assembly correctly. Then, the union nut is again screwed off the connecting element, and the pipe end is removed from the connecting element. The cutting depth of the cutting right is then subject to a visual inspection by the mechanic who decides whether the cutting ring has cut deeply enough into the pipe before the connecting assembly is reassembled. However, during the visual inspection it is possible for the supporting ring to slip off the pipe end and thus from the pipe, thus making reassembly more involved.

It is the object of the present invention to provide a connecting assembly, in which case assembly is simpler.

In accordance with the invention, this object is achieved by a connecting assembly for connecting a pipe with a connecting element having a tapered conical bore starting from a face, said connecting assembly comprising: a longitudinal axis; a pipe having a pipe end that can be inserted into the conical bore of the connecting element; a supporting ring having a conical bore starting from a first retaining surface and flaring in the same direction as the conical bore of the connecting element and having a second retaining surface being supported by the face of the connecting element; a union nut which can be screwed on a thread of the connecting element and which forms a tensioning surface and is supported axially at least indirectly on the supporting ring; a cutting ring seated in the conical bore of the supporting ring and provided with a pressure surface for the impingement of force by the tensioning surface of the union nut, and having at least one first cutting edge; and a collar bulge on the outer surface of the pipe formed by cutting the first cutting edge, said collar bulge's outside diameter being greater than the smallest inside diameter of the supporting ring and said collar bulge being located between the pipe end and the first retaining surface.

The geometric configuration of the cutting ring is such that, with adequate cutting depth of the cutting ring, the collar bulge has an outside diameter that is greater than the smallest inside diameter of the supporting ring. In so doing, it is ensured that the supporting ring cannot slip off the pipe following correct assembly and disassembly of the connecting assembly during a visual inspection of the cutting depth of the cutting ring.

Furthermore, the geometric configuration of the cutting ring is to be such that, in the case of inadequate cutting depth of the cutting ring, the collar bulge has an outside diameter that is smaller than the smallest inside diameter of the supporting ring, so that the supporting ring can be moved over the collar bulge toward the pipe end and be removed from the pipe.

Whether or not the cutting ring has cut sufficiently deeply into the pipe can be easily determined in that whether or not the supporting ring is held on the pipe following assembly and disassembly. If it cannot be moved over the collar bulge, the cutting depth is adequate. If it can be slid over the collar bulge, the cutting depth is inadequate.

Preferably, in assembled state of the connecting assembly, the supporting ring is held by its first retaining surface in abutment with the collar bulge. This can be achieved in that the cutting ring abuts axially flush against the first retaining surface of the supporting ring. However, the cutting ring may also project in axial direction from the conical bore of the supporting ring toward the pipe end and thus project from the first retaining surface of the supporting ring in the direction toward the pipe end.

Preferably, the union nut has a conical bore that forms a tensioning surface in the form of a conical surface tapering in a direction opposite the conical bore of the connecting element.

The cutting depth is a function of the cone angle of the conical bore of the supporting ring and the mounting length, whereby the mounting length is the length over which the cutting ring cuts into the pipe. For a limited and defined specification of the mounting path it may thus be provided that, in assembled state of the connecting assembly, the first abutment surface of the cutting ring is axially supported against the second abutment surface of the supporting ring.

Furthermore, it is preferable that the cutting ring have a first supporting surface by means of which the cutting ring is supported in radial direction toward the longitudinal axis against the second supporting surface of the supporting ring. In so doing, the first supporting surface may represent the first abutment surface, and the second supporting surface may represent the second abutment surface.

The support of the cutting ring against the supporting ring in radial direction toward the longitudinal axis ensures that, even when the union nut is tightened too much, the cutting ring is either not or only minimally deformed in radially inward direction by the conical surface of the union nut. Thus, any excessive constriction of the pipe is prevented. As a result of this, the assembly reliability is increased and, in particular in the case of thin-walled pipes, greater flexural strength is achieved. Furthermore, based on the fact that the cutting ring is internally supported in radial direction and cannot be displaced inward, a significantly more distinct torsional moment is created during assembly, thus indicating the end of assembly.

In the case of excessive tightening and, in particular, in the case of pipes consisting of high-quality material, the supporting ring is strongly stressed in radially outward direction and can burst. By supporting the cutting ring against the supporting ring in radially inward direction, the end of assembly is initiated by a radially inward component of force acting on the supporting ring, thus reducing the danger of bursting.

Considering standardized union nuts, the tensioning surface is configured in the form of a conical bore having an opening angle of 90°. Standardized connecting elements have a conical bore with an opening angle of 24°. As a rule, the opening angle of the conical bore of the supporting ring is adapted to that of the connecting element and is also 24°. Inasmuch as, however, the supporting ring is not a standardized component, this angle can be adapted in order to optionally also adapt the cutting depth of the cutting ring in the pipe. In so doing, the outside diameter of the collar bulge can also be adapted. Preferably, the opening angle is 13.2° to 24.6°. Considering a preferred thickness of a cutting edge section of the cutting ring that produces the cutting edge, said thickness being 0.22 mm to 0.58 mm, it is possible to achieve a cutting depth of 0.05 to 0.26 mm.

Preferably, the cutting ring has a supporting section and a cutting edge section, whereby the supporting section represents the first supporting section, and the cutting edge section is accommodated in the conical bore of the supporting ring.

The supporting surfaces may be conical. Preferably, the first supporting surface is represented by a peripheral undercut of the cutting ring, and the second supporting surface is represented by a peripheral projection of the supporting ring. In so doing, the peripheral projection is accommodated in the undercut.

The supporting ring may extend over a part of the length of the conical bore of the connecting element into said connecting element, so that the first retaining surface is located in the conical bore of the connecting element. As a result of this, the supporting ring, which is strongly stressed in radially outward direction, experiences a support in radially outward direction.

Preferably, the cutting edge section then extends into the conical bore of the connecting element. Therefore, it is ensured that the cutting edge section is indirectly supported radially against the connecting element, via the supporting ring extending into the conical bore of the connecting element. In this case, a cutting edge of the cutting ring may be arranged inside the conical bore of the connecting element which is thus radially supported.

Preferably, the cutting ring has two cutting edges. In so doing, one of the cutting edges may be located inside the conical bore of the connecting element, and the other cutting edge may be located outside the conical bore of the connecting element.

The conical bore of the connecting element, the supporting ring and the pipe may form an accommodation space in which a sealing ring is seated.

In assembled state of the connecting assembly, the union nut may be indirectly axially supported via the cutting ring against the supporting ring in such a manner that the union nut's tensional surface is supported axially against the pressure surface of the cutting ring and that a first supporting surface of the cutting ring is axially supported against a second supporting surface of the supporting ring.

Alternatively, it may be, in assembled state of the connecting assembly, that the tensioning surface of the union nut is directly axially supported by the second supporting surface of the supporting ring, as well by the pressure surface of the cutting ring.

Hereinafter, a preferred exemplary embodiment is explained in detail with reference to the drawings. They show in

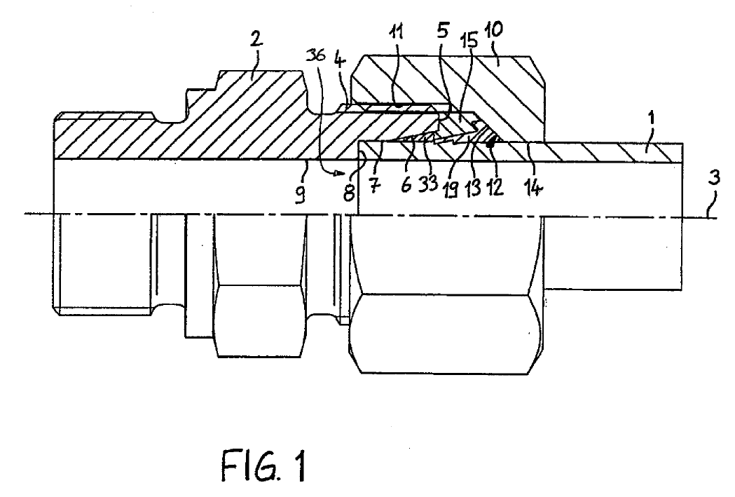

FIG. 1 a longitudinal section of the connecting assembly in accordance with the invention, in assembled state;

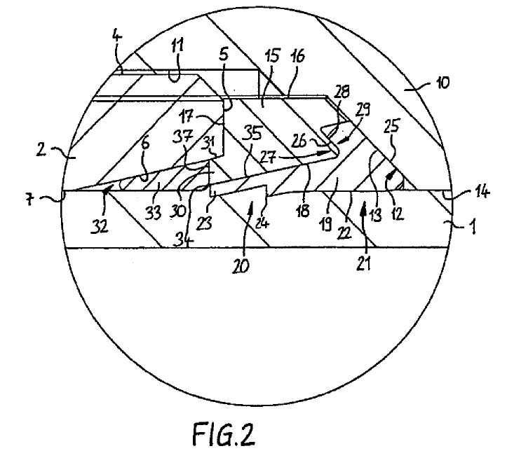

FIG. 2 an enlarged sectional view of the connecting assembly in accordance with FIG. 1; and,

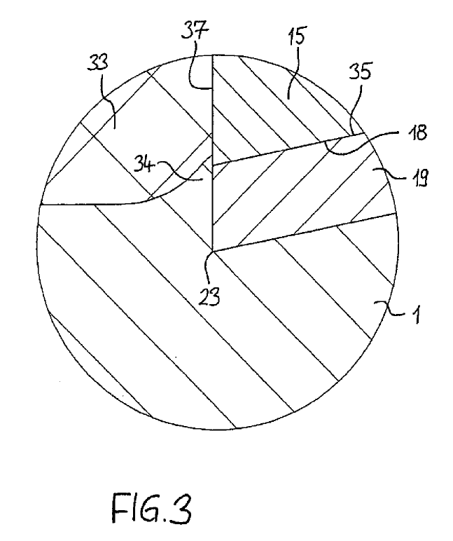

FIG. 3 an enlarged sectional view of the collar bulge in accordance with FIG. 1.

FIGS. 1 through 3 show a connecting assembly in accordance with the invention, in which case a pipe 1 is connected to a connecting element 2. Hereinafter, FIGS. 1 through 3 will be described together. The connecting assembly has a longitudinal axis 3, whereby the pipe 1 and the connecting element 2 are arranged centered thereto. The connecting element 2 has, on its outside surface, a thread 4 that starts at a face 5. Furthermore, starting from the face 5 is a conical bore 6 centered with respect to the longitudinal axis 3 and having a standardized opening angle of 24°. This adjoins a first cylindrical bore 7 having a diameter that matches the pipe 1. The first cylindrical bore 7 terminates in a ring surface 8 from which continues a second cylindrical bore 9 having a reduced diameter. The pipe 1 has a pipe end 36 that is used for insertion in the bore 7. The ring surface 8 is disposed to support the pipe 1 against the connecting element 2 in axial direction.

A union nut 10 is screwed onto the connecting element 2, said nut having a thread 11 matching the thread 4 of the connecting element 2. Adjoining the thread 11 is a conical bore 12 is provided on the end of the union nut 10 facing away from the connecting element 2, said conical bore 12 having a standardized opening angle of 90° and forming a tensioning surface 13 configured as a conical surface and tapering in a direction opposite the conical bore 6 of the connecting element 2. The conical bore 12 of the union nut 10 terminates in a cylindrical bore 14 having a reduced diameter, said latter bore matching the outside diameter of the pipe 1. The union nut 10 is slid over the pipe 1.

Furthermore, there is a supporting ring 15 having an outside surface 16 with a diameter that is dimensioned in such a manner that the union nut 10 with its thread 11 can pass it. The supporting ring 15 has a second retaining surface 17 which, in assembled state, is in planar abutment with the face 5 of the connecting element 2. Furthermore, the supporting ring 15 has a conical bore 18 that tapers in the direction opposite the conical bore 12 of the union nut 10. The opening angle of the conical bore 18 of the supporting ring 15 preferably is 13.2° to 24.6° and can therefore correspond to the standardized cone angle of 24° of the connecting element 2.

The pipe 1, the conical bore 6 of the connecting element 2 and a first retaining surface 37 of the supporting ring 15, together, form an accommodation space 32 for the accommodation of a sealing ring 33. The sealing ring 33 may be a separate ring or it may be permanently connected to the supporting ring 15, e.g., by vulcanizing.

Furthermore, a cutting ring 19 is provided. The cutting ring 19 has a cutting edge section 20, as well as a supporting section 21. The cutting edge section 20 is conical and seated in the conical bore 18 of the supporting ring 15. The cutting ring 19 has a bore 22 that is slid onto the pipe 1. In the region of the cutting edge section 20, the bore 22 is configured in such a manner that a front cutting edge 23 and a rear cutting edge 24 are formed.

The supporting section 21 is arranged toward the union nut 10. The supporting section 21 forms a conical pressure surface 25 that is adapted to the conical bore 12 of the union nut 10 and is in abutment with said nut.

An axial force is applied to the cutting ring 19 by screwing the union nut 10 onto the connecting element 2, and thus a collar bulge 34 is formed on the outside surface of the pipe 1. In assembled sate of the connecting assembly, the cutting ring 19 is axially supported against this bulge. As a result of this, the pipe 1 is axially supported against the cutting ring 19 and the latter, in turn, is supported against the union nut 10, so that the pipe 1 cannot be pulled out of the connecting element 2.

The geometric configuration of the cutting ring 19—i.e., the thickness of the cutting edge section 20, the opening angle of the conical surface 35 of the cutting ring 19 in the region of the cutting edge section 20, as well as the inside diameter of the cutting ring 19 in unassembled and not deformed state relative to the outside diameter of the pipe 1—is such that, with adequate cutting depth of the cutting ring 19, the collar bulge 34 has an outside diameter that is greater than the smallest inside diameter of the supporting ring 15. In so doing, the collar bulge 34 is located between the pipe end 36 and the first retaining surface 37. The first retaining surface 37 of the supporting ring 15 is held in abutment with the collar bulge 34. To accomplish this, the cutting ring 19 is at least axially flush with the first retaining surface 37 of the supporting ring. Accordingly, it is also possible for the first retaining surface 37 of the cutting edge section 20 to project out of the conical bore 18 of the supporting ring 15 in the direction toward the pipe end 36. Consequently, it is ensured that the supporting ring 15—after correct assembly and disassembly of the connecting assembly—cannot slip off the pipe 1 when a visual inspection of the cutting depth of the cutting ring 19 is performed.

Furthermore, the geometric configuration of the cutting ring 19 should be such that, in case of inadequate cutting depth of the cutting ring 19, the collar bulge 34 has an outside diameter that is smaller than the smallest inside diameter of the supporting ring 15, so that the supporting ring 15 can be moved over the collar bulge toward the pipe end 36 and be removed from the pipe 1.

Furthermore, the supporting section 21 forms a first supporting surface 26 that faces the supporting ring 15 and is represented by a peripheral undercut 27. The first supporting surfaces 26 opens conically in the direction toward the supporting ring 15.

The supporting ring 15 forms a second supporting surface 28 which also is conical and has the same opening angle as the first supporting surface 26. The second supporting surface 28 consists of a peripheral projection 29 of the supporting ring 15 that is accommodated in the undercut 27 of the cutting ring 19. The first supporting surface 26 is supported against the second supporting surface 28. Due to the conical configuration of the supporting surfaces 26, 28, the cutting ring 19 is supported against deformation in radially inward direction toward the longitudinal axis 3.

In addition, the first supporting surface 26 represents a first abutment surface, and the second supporting surface 28 represents a second abutment surface, whereby the cutting ring 19, in order to limit the assembly path, i.e., the path over which the cutting ring 19 cuts into the pipe 1, is supported by the first abutment surface 26 in axial direction against the second abutment surface 28 of the supporting ring 15.

Furthermore, the supporting ring 15 comprises a retaining section 30 with which the supporting ring 15 penetrates the conical bore 6 of the connecting element 2 and extends over part of the length of the conical bore 6. The retaining section 30 has an outside surface 31 that is also conical and is adapted to the conical bore 6 of the connecting element 2. The cutting edge section 20 of the cutting ring 19 penetrates the conical bore 18 of the supporting ring 15 to a depth at which it extends into the conical bore 6 of the connecting element 2. The front cutting edge 23 is configured on the end of the cutting edge section 20 penetrating the conical bore 6 of the connecting element 2 in such a manner that it is radially supported against the connecting element 2 via the retaining section 30. The rear cutting edge 24 is located inside the supporting ring 15 and outside the conical bore 6 of the connecting element 2. In so doing, higher bursting pressures of the cutting ring connection are achieved.

Furthermore, the retaining section 30 is disposed to tension the supporting ring 15 via the outside surface 31 of the retaining section 30 in the conical bore 6 of the connecting element 2 in such a manner that the frictional force between the connecting element 2 and the supporting ring 15 is greater than between the cutting ring 19 and the union nut 10. Furthermore, the frictional force between the supporting ring 15 and the cutting ring 19 is greater than between the cutting ring 19 and the union nut 10, so that, when the union nut 10 is tightened, said nut rotates relative to the cutting ring 19 and not the cutting ring 19 relative to the supporting ring 15, or the cutting ring 15 relative to the connecting element 2. Consequently, it is effectively avoided that the pipe 1 will rotate together with the union nut 10 when the union nut 10 is being tightened.

The radial support of the cutting ring 19 relative to the supporting ring 15 prevents a radial deformation of the cutting ring 19 and thus a construction of the pipe 1. Consequently, higher bursting pressures of the connecting assembly are achieved because there is less stress on the pipe 1. Furthermore, the end of the assembly is indicated by a distinct increase of the torsional moment.

### REFERENCE NUMBERS

1 Pipe
2 Connecting element
3 Longitudinal axis
4 Thread of the connecting element
5 Face
6 Conical bore of the connecting element
7 First cylindrical bore
8 Ring surface
9 Second cylindrical bore
10 Union nut
11 Thread of the union nut
12 Conical bore of the union nut
13 Tensioning surface
14 Cylindrical bore
15 Supporting ring
16 Outside surface
17 Second retaining surface
18 Conical bore of the supporting ring
19 Cutting ring
20 Cutting edge section
21 Supporting section
22 Bore
23 Front cutting edge
24 Rear cutting edge
25 Pressure surface
26 First supporting surface
27 Undercut
28 Second supporting surface
29 Projection
30 Retaining section
16, 31 Outside surface
32 Accommodation space
33 Sealing ring
34 Collar bulge
35 Conical surface of the cutting ring
36 Pipe end
37 First retaining surface

1-16. (canceled)

17. A connecting assembly for connecting a pipe with a connecting element having a conical bore that tapers starting from a face, the assembly comprising:
a longitudinal axis;
a pipe having a pipe end configured to be inserted into the conical bore of the connecting element;
a supporting ring having a conical bore starting from a first retaining surface and flaring in the same direction as the conical bore of the connecting element and having a second retaining surface supported by the face of the connecting element;
a union nut configured to be screwed on a thread of the connecting element and which forms a tensioning surface and is supported axially at least indirectly on the supporting ring;
a cutting ring seated in the conical bore of the supporting ring and provided with a pressure surface that is loaded by or accommodates a force exerted by the tensioning surface of the union nut, and having at least one first cutting edge; and
a collar bulge on the outer surface of the pipe formed by cutting the first cutting edge into the pipe;
wherein the outer diameter of the collar bulge is greater than the smallest inside diameter of the supporting ring, and the collar bulge is located between the pipe end and the first retaining surface.

18. The assembly in accordance with claim 17, wherein the first retaining surface of the supporting ring is in abutment with the collar bulge.

19. The assembly in accordance with claim 17, wherein the cutting ring is axially flush adjoining the first retaining surface of the supporting ring or projects axially in the direction of the pipe end.

20. The assembly in accordance with claim 17, wherein, in order to limit the assembly path, the cutting ring abuts with a first abutment surface axially against a second abutment surface of the supporting ring.

21. The assembly in accordance with claim 17, wherein the cutting ring has a first supporting surface by means of which the cutting ring is supported in radial direction toward the longitudinal axis against a second supporting surface of the supporting ring.

22. The assembly in accordance with claim 21, wherein the first supporting surface presents a first abutment surface, and the second supporting surface presents a second abutment surface, whereby the cutting ring, to limit the assembly path, is supported with the first abutment surface axially against the second abutment surface of the supporting ring.

23. The assembly in accordance with claim 21, wherein the cutting ring has a supporting section and a cutting edge section, whereby the supporting section provides the first supporting surface, and whereby the cutting edge section is accommodated in the conical bore of the supporting ring.

24. The assembly in accordance with claim 21, wherein the first and second supporting surfaces are conical.

25. The assembly in accordance with claim 21, wherein the first supporting surface is formed at least in part by a peripheral undercut of the cutting ring, and the second supporting surface is formed at least in part by a peripheral projection of the supporting ring.

26. The assembly in accordance with claim 17, wherein the supporting ring projects over part of the length of the conical bore of the connecting element into said connecting element, and the first retaining surface is located in the conical bore of the connecting element.

27. The assembly in accordance with claim 17, wherein the cutting edge section extends into the conical bore of the connecting element.

28. The assembly in accordance with claim 27, wherein the first cutting edge is located inside the conical bore of the connecting element.

29. The assembly in accordance with claim 17, wherein the cutting ring has a second cutting edge in addition to the first cutting edge.

30. The assembly in accordance with claim 17, wherein the union nut is indirectly axially supported against the supporting ring via the cutting ring.

31. The assembly in accordance with claim 30, wherein the tensioning surface of the union nut is axially supported against the pressure surface of the cutting ring, and that the first supporting surface of the cutting ring is axially supported against a second supporting surface of the supporting ring.

32. The assembly in accordance with claim 17, wherein the tensioning surface of the union nut is axially supported against the second supporting surface of the supporting ring as well as against the pressure surface of the cutting ring.
